(19) United States
(12) Patent Application Publication
(10) Pub. No.: US 2014/0104876 A1
(43) Pub. Date: Apr. 17, 2014

(54) LIGHT-GUIDING PLATE, LIGHT-EMITTING MODULE AND DISPLAY APPARATUS

(71) Applicants: InnoLux Corporation, Miao-Li County (TW); INNOCOM TECHNOLOGY (SHENZHEN) CO., LTD, Shenzhen City (CN)

(72) Inventors: Jen-Chih YANG, Miao-Li County (TW); Cheng-Cheng PAN, Miao-Li County (TW); Ta-Chin HUANG, Miao-Li County (TW); Chou-Yu KANG, Miao-Li County (TW); Pu-Chun CHU, Miao-Li County (TW)

(73) Assignees: InnoLux Corporation, Miao-Li County (TW); INNOCOM TECHNOLOGY (SHENZHEN) CO., LTD, Shenzhen City (CN)

(21) Appl. No.: 14/050,869

(22) Filed: Oct. 10, 2013

(30) Foreign Application Priority Data
Oct. 16, 2012 (TW) 101138069

(51) Int. Cl. F21V 8/00

(52) U.S. Cl. CPC G02B 6/0013
USPC 362/609; 362/612; 362/621

(57) ABSTRACT

A light-emitting module comprises a light-guiding plate, a plurality of light-guiding elements and a light-emitting unit. The light-guiding plate guides the light direction and has at least an incident surface and two opposite surfaces. The light-guiding elements are disposed on one of the surfaces of the light-guiding plate, and each include a rough surface having a maximum roughness larger than zero micron and less than or equal to 20 microns. The light-emitting unit is disposed to the incident surface of the light-guiding plate. The light emitted by the light-emitting unit is applied to the light-guiding plate, and then, by the guiding of the light-guiding plate and the light-guiding elements, is outputted through one of the surfaces of the light-guiding plate in an alternate form of bright and dark zones. The invention also discloses a light-guiding plate and a display apparatus.

### CROSS REFERENCE TO RELATED APPLICATIONS

This Non-provisional application claims priority under 35 U.S.C. §119(a) on Patent Application No(s). 101138069 filed in Taiwan, Republic of China on Oct. 16, 2012, the entire contents of which are hereby incorporated by reference.

### BACKGROUND OF THE INVENTION

1. Field of Invention

The invention relates to a light-guiding plate, a light-emitting module and a display apparatus.

2. Related Art

Recently, because the manufacturing process and material of light-emitting diode (LED) are improved unceasingly, the light-emitting efficiency of LED is enhanced enormously. Different from the fluorescent lamp or compact fluorescent lamp, LED has some wonderful characteristics, such as less power consumption, long lifespan, high safety, short response time and small size, thus gradually applied to a lighting apparatus or a lighting module. The lighting apparatus is such as an indoor or outdoor lamp, a flashlight, a headlight or taillight of a vehicle, or other kind of the lighting apparatus. The lighting module can be applied to function as a backlight module of a display apparatus or otherwise.

FIG. 1 is a schematic side-view of a conventional display apparatus 9.

The display apparatus 9 includes a display panel T and a light-emitting module 1. The light-emitting module 1 is a backlight module of the display apparatus 9, emitting the light L through the display panel T so that the display apparatus 9 can display images.

The light-emitting module 1 includes two lateral light sources 121, a light-guiding plate 122 and a plurality of light-guiding elements 123. The lateral light sources 121 are instanced as two LED light bars. They are disposed on two opposite sides of the light-guiding plate 122, respectively, and emit the light L applied to the light-guiding plate 122 through an incident surface I of the light-guiding plate 122. Each of the light-guiding elements 123 is a microstructure (a recess), and disposed on a bottom surface B1 of the light-guiding plate 122 with an overlooking form of a straight line parallel with the incident surface I. The light is guided to the central portion of the light-guiding plate 122 from the lateral sides of the light-guiding plate 122 by the total reflection. The light-guiding elements 123 can destroy the total reflection of the light so that the light can be guided and then emitted through a light output surface O of the light-guiding plate 122 and towards the display panel 11 for displaying images.

When the light emitted by the light sources 121 is applied to the light-guiding plate 122 and is then outputted through the light output surface O by the light-guiding elements 123, the light-guiding elements 123 will cause the light through the light output surface O to generate a light output area A (i.e. the area bounded by the lights L1 and L2), and the light in the light output area A can not be uniform because the inner wall of the light-guiding elements 123 has different reflection angles. Accordingly, the whole light-emitting module 1 and even the display apparatus 9 can not have uniform light output.

Therefore, it is an important subject to provide a light-guiding plate, a light-emitting module and a display apparatus that can change the light output form so as to achieve the uniform light output to improve the display quality.

### SUMMARY OF THE INVENTION

In view of the foregoing subject, an objective of the invention is to provide a light-guiding plate, a light-emitting module and a display apparatus that can change the light output form so as to achieve the uniform light output to improve the display quality.

To achieve the above objective, a light-emitting module of the invention comprises a light-guiding plate, a plurality of light-guiding elements and a light-emitting unit. The light-guiding plate guides the light direction and has at least an incident surface and two opposite surfaces. The light-guiding elements are disposed on one of the surfaces of the light-guiding plate, and each include a rough surface having a maximum roughness larger than zero micron and less than or equal to 20 microns. The light-emitting unit is disposed to the incident surface of the light-guiding plate. The light emitted by the light-emitting unit is applied to the light-guiding plate, and then, by the guiding of the light-guiding plate and the light-guiding elements, is outputted through one of the surfaces of the light-guiding plate in an alternate form of bright and dark zones.

In one embodiment, the any two adjacent light-guiding elements have an interval between zero and a width of the surface where the light-guiding elements are disposed.

In one embodiment, a centerline of each of the light-guiding elements and a short side of the surface where the light-guiding elements are disposed have an included angle between zero and 90 degrees.

In one embodiment, the cross-section of each of the light-guiding elements is shaped like a recess or a protrusion by a view along the direction parallel with the incident surface.

In one embodiment, the light-guiding elements are each configured with a reflective material.

In one embodiment, the cross-section of each of the light-guiding elements is substantially a convex, a polygon, or an irregular form.

In one embodiment, by a view along the direction perpendicular to the surface where the light-guiding elements are disposed, the width of a short side of each of the light-guiding elements is between 50 μm and 150 μm.

To achieve the above objective, a display apparatus of the invention comprises a display panel and a light-emitting module. The light-emitting module is disposed opposite to the display panel and includes a light-guiding plate, a plurality of light-guiding elements and a light-emitting unit. The light-guiding plate guides the light direction and has at least an incident surface and two opposite surfaces. The light-guiding elements are disposed on one of the surfaces of the light-guiding plate, and each includes a rough surface having a maximum roughness larger than zero micron and less than or equal to 20 microns. The light-emitting unit is disposed to the incident surface of the light-guiding plate. The light emitted by the light-emitting unit is applied to the light-guiding plate, and then, by the guiding of the light-guiding plate and the light-guiding elements, is outputted through one of the surfaces of the light-guiding plate in an alternate form of bright and dark zones.

To achieve the above objective, a light-guiding plate of the invention comprises at least an incident surface, two opposite surfaces, and a plurality of light-guiding elements. The light-guiding elements are disposed on one of the surfaces of the light-guiding plate, and each include a rough surface having a maximum roughness larger than zero micron and less than or equal to 20 microns.

As mentioned above, a plurality of light-guiding elements are disposed to one of the surfaces of the light-guiding plate of the invention, and each includes a rough surface with a maximum roughness larger than 0 microns and less than or equal to 20 microns. Thereby, when the light is emitted to the display panel through the surface of the light-guiding plate of the light-emitting module, the light can be formed into an alternate form of bright and dark zones on the surface by the disposition of plural light-guiding elements. Furthermore, by the rough surface of each of the light-guiding elements, the reflected light can show the uniformity. Thus, the whole light-emitting module and the display apparatus can have uniform light output. Accordingly, the light-guiding plate, light-emitting module and display apparatus of the invention can change the light output form to have the uniform light output so that the display quality is improved.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic side-view of a conventional display apparatus;

FIG. 2A is a schematic diagram of a display apparatus of a preferred embodiment of the invention;

FIG. 2B is a side view of the display apparatus in FIG. 2A;

FIG. 2C is an enlarged diagram of the display apparatus in FIG. 2A;

FIG. 2D is a schematic diagram in which the rough surface of the light-guiding element in FIG. 2C is stretched out imaginarily on a plane; and

FIGS. 3A to 3C are schematic side-views of display apparatuses of different embodiments of the invention.

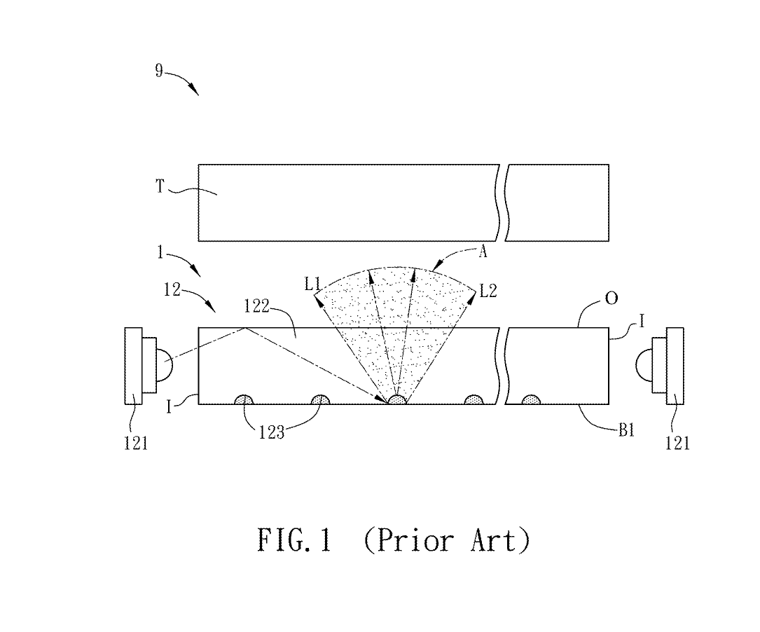

### DETAILED DESCRIPTION OF THE INVENTION

The present invention will be apparent from the following detailed description, which proceeds with reference to the accompanying drawings, wherein the same references relate to the same elements.

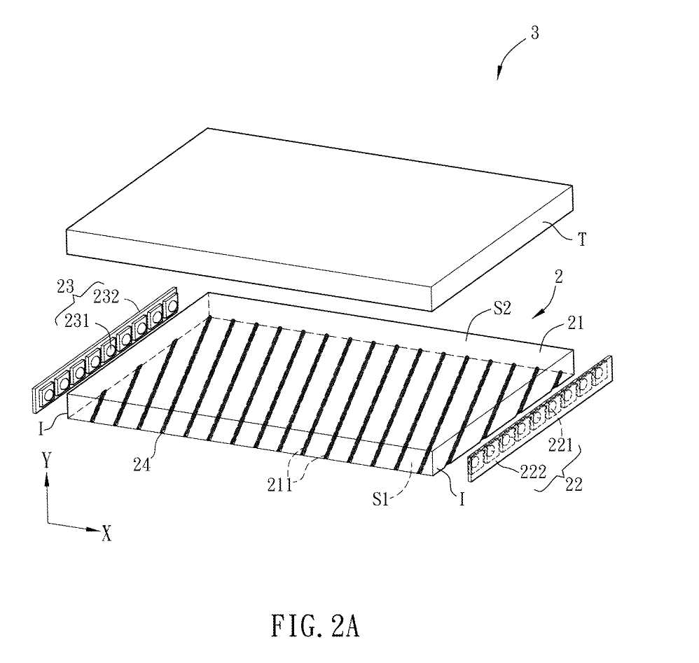

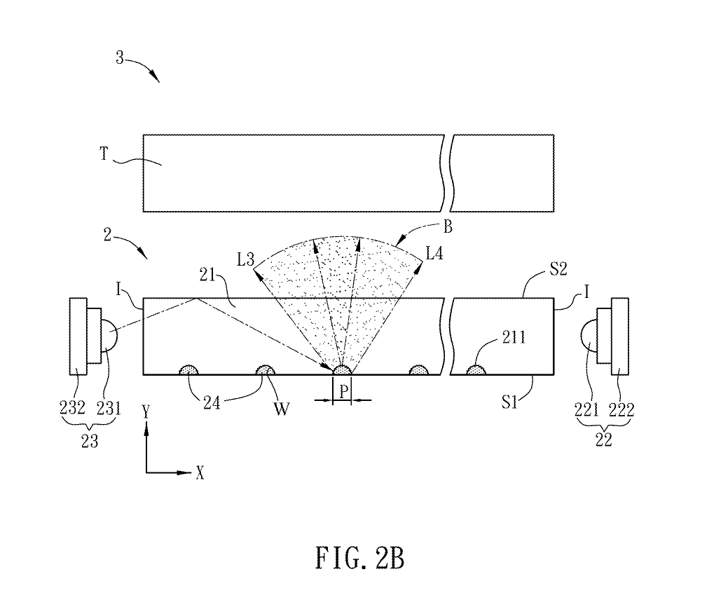

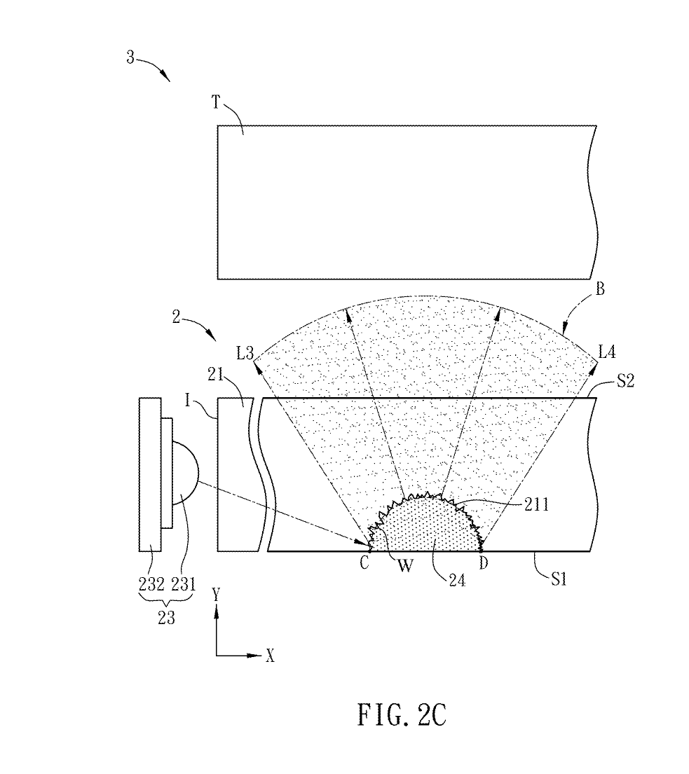

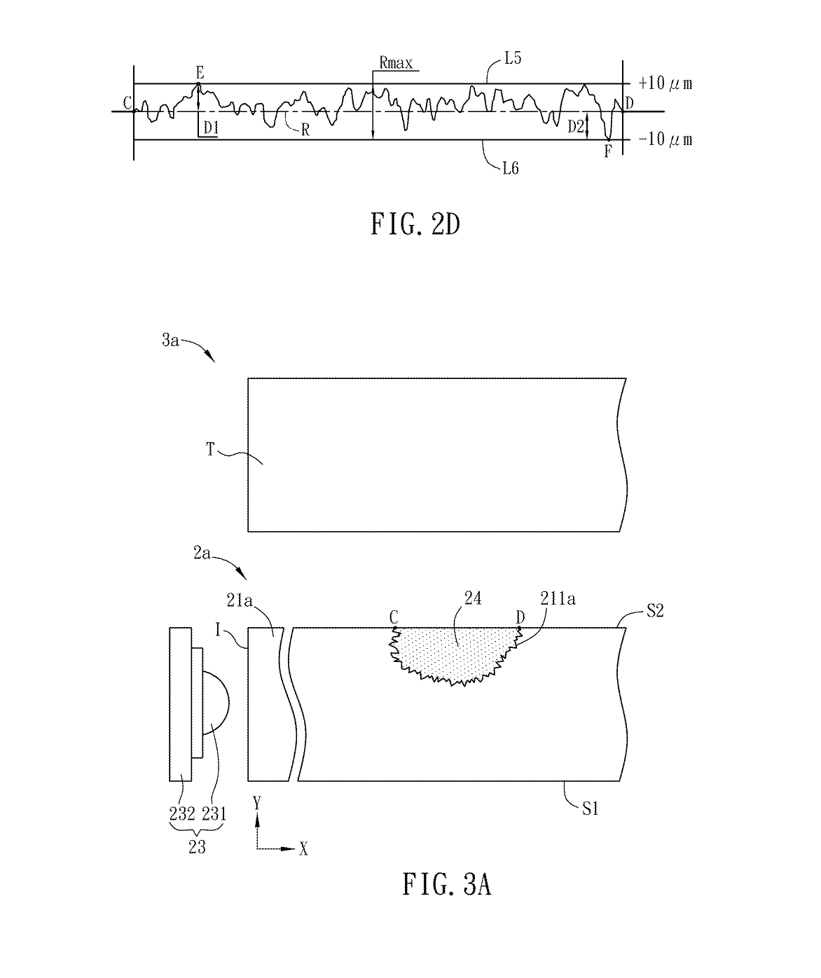

FIG. 2A is a schematic diagram of a display apparatus 3 of a preferred embodiment of the invention, FIG. 2B is a side view of the display apparatus 3, and FIG. 2C is an enlarged diagram of the display apparatus 3. Herein, FIGS. 2A to 2C are just schematic, but not for showing the real dimensions of the objects.

The display apparatus 3 includes a display panel T and a light-emitting module 2. In the invention, the light-emitting module 2 can be applied to function as a backlight module of the display apparatus 3, and otherwise, it can be applied to function as a parallax barrier device or a parallax prism device of a stereoscopic display apparatus, or as a lighting apparatus.

The light-emitting module 2 is disposed opposite to the display panel T, and includes a light-guiding plate 21, a plurality of light-guiding elements 211 and a light-emitting unit.

The light-guiding plate 21 can guide the light direction, and has at least an incident surface I and two opposite surfaces. As shown in FIG. 2B, in this embodiment, the light-guiding plate 21 has two opposite surfaces S1 and S2. The light-guiding plate 21 is used for guiding the traveling direction of the light, and made of transparent material, such as acrylic resin, polycarbonate, polyethylene resin, or glass. The said transparent materials are just for example, but not for limiting the scope of the invention. The refractive index of the transparent material is larger than that of the surrounding substance (e.g. air, the refractive index of which is about 1). Accordingly, the light with a specific incident angle can be provided the total reflection at the interface of the light-guiding plate 21 and the surrounding substance, so that the light applied through the incident surface can be guided to the central portion of the light-guiding plate 21, thereby generating more average light output form. A cross-section of the light-guiding plate 21 can be shaped like a plate or a wedge, for example, by viewing along a direction parallel with the surface S1. Herein, a plate-shaped light-guiding plate 21 is instanced.

The surfaces S1 and S2 are disposed oppositely. Herein, the surfaces S1 and S2 are the surfaces of the light-guiding plate 21 having larger area. For example, the surface S1 is a bottom surface of the light-guiding plate 21, and the surface S2 is a top surface of the light-guiding plate 21. The incident surface I is perpendicular to the surfaces S1 and S2. The number of the incident surface I is corresponding to the number of the light-emitting unit 22, and is at least 1. A viewer is generally located on the side of the surface S2 to overlook the light-emitting module 2.

The light-guiding elements 211 are disposed to at least one of the surfaces S1 and S2 of the light-guiding plate 21, guiding or changing the traveling direction of the light by scattering, or reflecting, etc., for causing the desired light output form. The light-guiding elements 211 can be formed on the surface by mechanical process or chemical process. The light-guiding elements 211 can be located anywhere in the light-guiding plate 21 except the incident surface I. For example, all the surfaces of the light-guiding plate 21 except the incident surface I can be configured with the light-guiding elements 211, and even the inside of the light-guiding plate 21, excluding the surfaces, can be configured with the light-guiding elements 211. Herein, as shown in FIGS. 2A and 2B, the light-guiding elements 211 are disposed at the surface S1 (bottom surface) of the light-guiding plate 21, for example. By a view along the direction parallel with the incident surface I (or parallel with the surface S1, i.e. the front side of FIG. 2A), the light-guiding element 211 can be a microstructure of a recess or a protrusion. By viewing along a direction perpendicular to the surface S2 (i.e. overlooking), the light-guiding element 211 and the incident surface I substantially have an included angle. In this embodiment, each of the light-guiding elements is substantially a microstructure concaved towards the surface S2, so its cross-section has a really small width. By a view along the direction perpendicular to the surface S2 (overlooking), as shown in FIG. 2A, each of the light-guiding elements 211 substantially has a centerline, and the centerline is an oblique line which is not parallel with both of a direction X and a direction Y (the direction Y can be along a short side of the surface S1 or along a short side of the incident surface I; the direction X is perpendicular to the direction Y and can be along a long side of the surface S1). The centerline of each of the light-guiding elements 211 and the direction X or Y can have an included angle (acute angle), which can be between 0 and 90 degrees. Therefore, by overlooking the light-guiding plate 21, each of the light-guiding elements 211 substantially can be regarded as an oblique line.

In this embodiment, each of the light-guiding elements 211 is an oblique line inclined to the left side. In other embodiments, it can be an oblique line inclined to the right side, or can be an oblique curve. Otherwise, a portion of the light-guiding elements 211 can be inclined to the right side while the other inclined to the left side. As shown in FIG. 2B, by a view along the direction perpendicular to the surface S1 where the light-guiding elements 211 are disposed (i.e. a bottom view), the short side of each of the light-emitting elements 211 has an opening with a width P between 50 microns and 150 microns. The any two light-guiding elements 211 has an interval between zero and a width of the surface S1 where the light-guiding elements 211 are disposed, and they don't contact or connect each other.

As shown in FIG. 2C, each of the light-guiding elements 211 has a rough surface. Herein, an inner wall W of each of the light-guiding elements 211 is a rough surface. By a view along the direction parallel with the incident surface I (i.e. a front view), the cross-section of each of the light-guiding elements 211 can be a convex, a polygon (including a triangle, a square, a rectangle, a trapezoid, or a regular polygon), or an irregular form. Herein, the cross-section of each of the light-guiding elements 211 is instanced as a convex, such as a semicircle. The cross-sections of the light-guiding elements 211 can be the same or different. In this embodiment, all the light-guiding elements 211 are instanced with the same cross-section, interval and slope.

The light-emitting units 22 and 23 are disposed to the incident surface I of the light-guiding plate 21. In this embodiment, two light-emitting units 22 and 23 are respectively disposed to the opposite incident surfaces I for example. The light emitted by the light-emitting units 22 and 23 is applied to the light-guiding plate 21 through the incident surfaces I, and then are outputted through the surface S2 (i.e. the light output surface) that is opposite to the surface S1. The light-emitting units 22 and 23 can each include, for example, at least a light-emitting diode (LED), at least an organic light-emitting diode (OLED), at least a cold cathode fluorescent lamp (CCFL), or at least a hot cathode fluorescent lamp (HCFL), as a light source of the light-emitting units 22 and 23. Herein, the light-emitting units 22 and 23 are each instanced as an LED light bar including a plurality of LEDs 221 or 231 disposed on a circuit board 222 or 232. In other embodiments, only a light-emitting unit 22 can be disposed, emitting the light into the light-emitting plate 21 through the incident surface I of the light-emitting plate 21.

Reflective materials 24 are respectively disposed on the light-guiding elements 211, and capable of reflecting the light emitted by the light-emitting units 22 and 23. The reflective material 24 can be disposed on an inner wall W of the recess of the light-guiding element 211 or on an outer wall of the protrusion of the light-guiding element 211, or can be disposed into the recess of the light-guiding element 211. Herein, the reflective materials 24 are instanced as disposed in the recesses of the light-guiding elements 211 fully. In this embodiment, the reflective material 24 in the light-guiding element 211 can destroy the total reflection of the light L so that the light L can be emitted out through the surface S2 of the light-guiding plate 21 (in the case of the reflective material 24 disposed on the outer wall of the protrusion, the reflective material 24 can block the travelling of the light so that the light L can be reflected by the surface for some use). The reflective material 24 can include oxide, such as white SiO2, TiO2, or other substances of high reflectance. To deserve to be mentioned, the light-guiding element 211 can be configured without the reflective material 24, so the light L is guided only by scattering and then outputted through one of the surfaces in an alternate form of bright and dark zones.

As shown in FIGS. 2C and 2D, the definition of the maximum roughness (Rmax) of the inner wall W having a rough surface of the light-guiding element 211 is illustrated as below. FIG. 2D is a schematic diagram in which the inner wall W of the light-guiding element 211 in FIG. 2C is stretched out imaginarily on a plane (i.e. from the point C to the point D in FIG. 2C is stretched out on a plane to show the rough surface of the inner wall W on the plane). Besides, FIG. 2D is only for illustrating the definition of the maximum roughness (Rmax), but not for actually showing the form of the inner wall W of the light-guiding element 211.

In the invention, the maximum roughness (Rmax) of the rough surface of the inner wall W of the light-guiding element 211 is larger than 0 micron, and less than or equal to 20 microns. Herein, the maximum roughness (Rmax) is defined as an interval between the lines L5 and L6 which respectively pass through a highest point (i.e. point E) and a lowest point (i.e. point F) of the feature line of the rough surface from the point C to the point D, and are parallel with a reference R (which is an average line of the feature line of the rough surface). In other words, the maximum roughness Rmax is the distance between the highest point E and the lowest point F along the direction perpendicular to the reference line R from the point C to the point D, and that is to say, the maximum roughness conforms to the equation as Rmax=D1+D2. Specifically, in this embodiment, the vertical distance D1 from the highest point E of the rough surface of the inner wall W to the reference line R can be equal to 10 microns, and the vertical distance D2 from the lowest point F of the rough surface to the reference line R can be equal to 10 microns. In other embodiments, the vertical distances D1 and D2 each can be less than 10 microns.

Accordingly, the light L emitted by the light-emitting units 22 and 23 is applied to the light-guiding plate 21 through the incident surfaces I, and then is provided the total reflection in the light-guiding plate 21. Besides, the inner wall W of each of the light-guiding elements 211 is a rough surface with a maximum roughness (Rmax) less than or equal to 20 microns. Thereby, when the light is emitted to the display panel T through the surface S2 of the light-guiding plate 21 of the light-emitting module 2, the light can be formed into an alternate form of bright and dark zones on the surface S2 by the disposition of plural light-guiding elements 211. Furthermore, by the rough surface of each of the light-guiding elements 211, the reflected light can generate a light output area B (i.e. the area bounded by the lights L3 and L4 in FIG. 2C) full of uniform light. Accordingly, the light output form of the invention is changed so that the light reflected by each of the light-guiding elements 211 can show the uniformity, and the whole light-emitting module 2 and the display apparatus 3 can thus have uniform light output so as to improve the display quality.

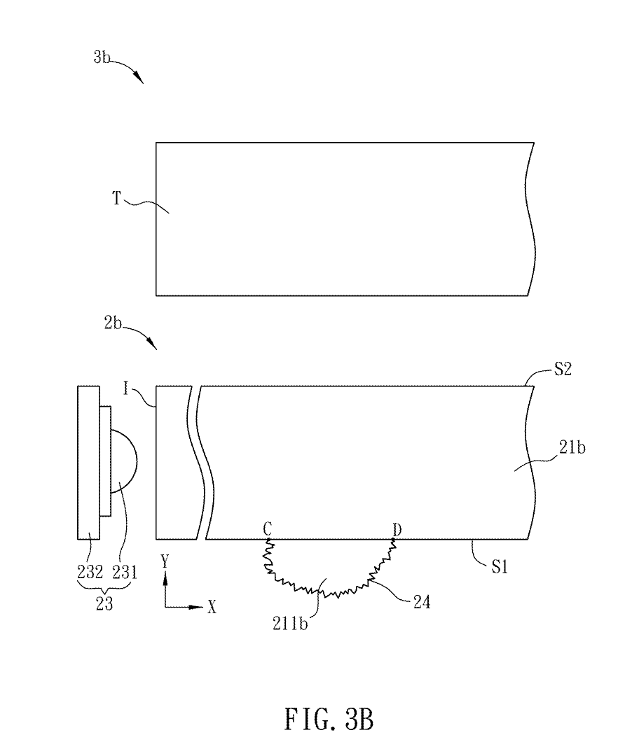

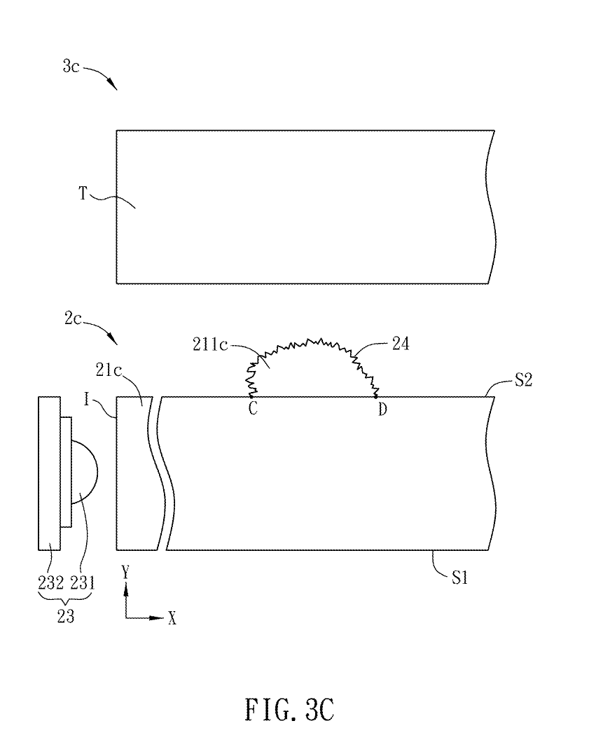

FIG. 3A is a schematic side-view of a display apparatus 3a of another embodiment of the invention.

Different from the display apparatus 3, the light-guiding elements 211a of the light-guiding plate 21a of the display apparatus 3a of this embodiment are each an irregular form, and are each a recess located on the surface 52 (the top surface). The reflective material 24 is disposed in the recess.

FIG. 3B is a schematic side-view of a display apparatus 3b of another embodiment of the invention.

Different from the display apparatus 3, the light-guiding elements 211b of the light-guiding plate 21b of the display apparatus 3b of this embodiment are each a microstructure of a protrusion located on the surface S1 (the bottom surface). The reflective material 24 is disposed on the outer wall of the protrusion.

FIG. 3C is a schematic side-view of a display apparatus 3c of another embodiment of the invention.

Different from the display apparatus 3b, the light-guiding elements 211c of the light-guiding plate 21c of the display apparatus 3c of this embodiment are each a microstructure of a protrusion located on the surface S2 (the top surface). The reflective material 24 is disposed on the outer wall of the protrusion.

Other technical features of the light-emitting apparatuses 3a to 3c can be understood by referring to the display apparatus in FIG. 2B, so the detailed descriptions are omitted here.

In summary, a plurality of light-guiding elements are disposed to one of the surfaces of the light-guiding plate of the invention, and each includes a rough surface with a maximum roughness larger than 0 microns and less than or equal to 20 microns. Thereby, when the light is emitted to the display panel through the surface of the light-guiding plate of the light-emitting module, the light can be formed into an alternate form of bright and dark zones on the surface by the disposition of plural light-guiding elements. Furthermore, by the rough surface of each of the light-guiding elements, the reflected light can show the uniformity. Thus, the whole light-emitting module and the display apparatus can have uniform light output. Accordingly, the light-guiding plate, light-emitting module and display apparatus of the invention can change the light output form to have the uniform light output so that the display quality is improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting module, comprising:
a light-guiding plate guiding the light direction and having at least an incident surface and two opposite surfaces;
a plurality of light-guiding elements disposed on one of the surfaces of the light-guiding plate, and each of the light-guiding elements including a rough surface having a maximum roughness larger than zero micron and less than or equal to 20 microns; and
a light-emitting unit disposed to the incident surface of the light-guiding plate,
wherein the light emitted by the light-emitting unit is applied to the light-guiding plate, and then, by the guiding of the light-guiding plate and the light-guiding elements, is outputted through one of the surfaces of the light-guiding plate in an alternate form of bright and dark zones.

2. The light-emitting module as recited in claim 1, wherein the any two adjacent light-guiding elements have an interval between zero and a width of the surface where the light-guiding elements are disposed.

3. The light-emitting module as recited in claim 1, wherein a centerline of each of the light-guiding elements and a short side of the surface where the light-guiding elements are disposed have an included angle between zero and 90 degrees.

4. The light-emitting module as recited in claim 1, wherein the cross-section of each of the light-guiding elements is shaped like a recess or a protrusion by a view along the direction parallel with the incident surface.

5. The light-emitting module as recited in claim 4, wherein the light-guiding elements are each configured with a reflective material.

6. The light-emitting module as recited in claim 4, wherein the cross-section of each of the light-guiding elements is substantially a convex, a polygon, or an irregular form.

7. The light-emitting module as recited in claim 1, wherein by a view along the direction perpendicular to the surface where the light-guiding elements are disposed, the width of a short side of each of the light-guiding elements is between 50 μm and 150 μm.

8. A display apparatus, comprising:
a display panel; and
a light-emitting module disposed opposite to the display panel and including a light-guiding plate, a plurality of light-guiding elements and a light-emitting unit, wherein the light-guiding plate guides the light direction and has at least an incident surface and two opposite surfaces, the light-guiding elements are disposed on one of the surfaces of the light-guiding plate, and each includes a rough surface having a maximum roughness larger than zero micron and less than or equal to 20 microns, the light-emitting unit is disposed to the incident surface of the light-guiding plate,
wherein the light emitted by the light-emitting unit is applied to the light-guiding plate, and then, by the guiding of the light-guiding plate and the light-guiding elements, is outputted through one of the surfaces of the light-guiding plate in an alternate form of bright and dark zones.

9. The display apparatus as recited in claim 8, wherein the any two adjacent light-guiding elements have an interval between zero and a width of the surface where the light-guiding elements are disposed.

10. The display apparatus as recited in claim 8, wherein a centerline of each of the light-guiding elements and a short side of the surface where the light-guiding elements are disposed have an included angle between zero and 90 degrees.

11. The display apparatus as recited in claim 8, wherein the cross-section of each of the light-guiding elements is shaped like a recess or a protrusion by a view along the direction parallel with the incident surface.

12. The display apparatus as recited in claim 11, wherein the light-guiding elements are each configured with a reflective material.

13. The display apparatus as recited in claim 11, wherein the cross-section of each of the light-guiding elements is substantially a convex, a polygon, or an irregular form.

14. The display apparatus as recited in claim 8, wherein by a view along the direction perpendicular to the surface where the light-guiding elements are disposed, the width of a short side of each of the light-guiding elements is between 50 μm and 150 μm.

15. A light-guiding plate, comprising:
at least an incident surface;
two opposite surfaces; and
a plurality of light-guiding elements disposed on one of the surfaces of the light-guiding plate, and each including a rough surface having a maximum roughness larger than zero micron and less than or equal to 20 microns.

16. The light-guiding plate as recited in claim 15, wherein the any two adjacent light-guiding elements have an interval between zero and a width of the surface where the light-guiding elements are disposed.

17. The light-guiding plate as recited in claim 15, wherein a centerline of each of the light-guiding elements and a short side of the surface where the light-guiding elements are disposed have an included angle between zero and 90 degrees.

18. The light-guiding plate as recited in claim 15, wherein the cross-section of each of the light-guiding elements is shaped like a recess or a protrusion by a view along the direction parallel with the incident surface.

19. The light-guiding plate as recited in claim 15, wherein the light-guiding elements are each configured with a reflective material.

20. The light-guiding plate as recited in claim 15, wherein by a view along the direction perpendicular to the surface where the light-guiding elements are disposed, the width of a short side of each of the light-guiding elements is between 50 μm and 150 μm.
